(19) United States
(12) Patent Application Publication
(10) Pub. No.: US 2010/0229899 A1
(43) Pub. Date: Sep. 16, 2010

(54) METHOD AND APPARATUS FOR CLEANING PROCESSING EQUIPMENT

(76) Inventor: TORBEN M. ANDERSEN, Hudson, OH (US)

Correspondence Address: TAROLLI, SUNDHEIM, COVELL & TUMMINO L.L.P., 1300 EAST NINTH STREET, SUITE 1700, CLEVELAND, OH, 44114, US

(21) Appl. No.: 12/721,942

(22) Filed: Mar. 11, 2010

Related U.S. Application Data
(60) Provisional application No. 61/159,978, filed on Mar. 13, 2009.

(51) Int. Cl. B08B 3/00

(52) U.S. Cl. 134/34

(57) ABSTRACT

An improved method and apparatus includes operating a multistage supply pump to induce a flow of the cleaning solution through one or more supply conduits to one or more dispensing devices. The multistage pump contains a plurality of impellers which are driven by a variable speed electric motor. The speed of operation of the multistage pump is varied as a function of variations in the fluid pressure in a supply conduit. A single stage return pump induces a flow of solution from the receptacle. A total organic carbon analyzer is utilized to determine the concentration of organic carbon in a return flow of solution from the receptacle. The electrical conductivity of the return solution is measured and is applied as a threshold value to initiate use of the total organic carbon analyzer. An acoustic sensor is utilized to sense variations in operation of the cleaning apparatus.

### RELATED APPLICATION

This application hereby claims the benefit of the early filing date of U.S. provisional application Ser. No. 61/159,978 filed Mar. 13, 2009. The disclosure in the aforementioned provisional application Ser. No. 61/159,978 is hereby incorporated herein in its entirety by this reference thereto.

### BACKGROUND OF THE INVENTION

The present invention relates to a method and apparatus for cleaning processing equipment which includes a receptacle which holds material during operation of the processing equipment.

Clean-in-place equipment and methods have been used for the cleaning of the interior surfaces of material processing equipment without disassembly of the processing equipment or with as little disassembly and operator intervention as possible. The processing equipment may include pipes, vessels, machines, and associated fittings. Industries that rely heavily on clean-in-place methods are those that require a high level of hygiene and include dairy, beverage, brewing, pharmaceutical and food processing industries. Once the equipment has been cleaned, it is important to be able to document and validate the cleaning process to enable subsequent verifying that the cleaning process was performed correctly.

Known methods and apparatus for use in cleaning material processing equipment are disclosed in U.S. Pat. Nos. 3,802,447; 5,603,826; and 6,161,558. Methods and apparatus for use in cleaning material processing equipment are also disclosed in U.S. Published Patent Application No. 2006/0196529.

### SUMMARY OF THE INVENTION

The present invention relates to a new and improved method and apparatus for the cleaning of processing equipment. The processing equipment may include a receptacle which holds material during operation of the processing equipment. A cleaning solvent, which is suitable for use in removing material remaining in the receptacle, is selected. The concentration of the selected cleaning solvent to be used in a cleaning solution is determined. In addition, the arrangement of surfaces in the receptacle which are to be cleaned is determined. One or more dispensing devices may be located at selected positions in the receptacle.

Equipment for use in cleaning the receptacle may include a tank which is at least partially filled with a cleaning solution containing the selected cleaning solvent. A multistage pump having a plurality of impellers may be utilized to pump the cleaning solution from the tank to a supply conduit. The speed at which the pump is driven may be varied as a function of fluid pressure in the supply conduit. A single stage return pump having a single impeller may be used to pump cleaning solution from the receptacle.

The multistage pump may be operated to discharge cleaning solution from the pump to the supply conduit at a rate of between 10 gallons per minute and 125 gallons per minute. The fluid flow from the multistage pump may be at a pressure between 60 pounds per square inch (gauge) and 250 pounds per square inch (gauge).

If desired, control apparatus associated with the cleaning equipment may include an acoustic sensor. The acoustic sensor is operable to detect sound resulting from the dispensing of cleaning solution from the dispensing device in the receptacle. A control function is initiated in response to sensing a change in the sound resulting from the dispensing of the cleaning solution.

If desired, the concentration of organic carbon contained in the cleaning solution pumped from the receptacle may be determined. The concentration of organic carbon may be determined after the electrical conductivity of the cleaning solution has been sensed. The sensing of the electrical conductivity of the cleaning solution may occur while operation of the return pump is interrupted.

The present invention has a plurality of features which may be utilized together as disclosed herein. Alternatively, the various features of the present invention may be used separately or in various combinations with each other. It is contemplated that one or more of the features of the present invention may be utilized in association with features from the prior art.

### BRIEF DESCRIPTION OF THE DRAWINGS

The foregoing and other features of the invention will become more apparent upon a consideration of the following description taken in connection with the accompanying drawings wherein:

FIG. 1 is a simplified schematic illustration depicting the relationship between a clean-in-place unit, constructed and operated in accordance with the present invention, and processing equipment to be cleaned during operation of the clean-in-place unit;

FIG. 2 is a simplified schematic illustration depicting the construction of some of the equipment in the clean-in-place unit of FIG. 1;

FIG. 3 is a simplified fragmentary schematic illustration depicting the construction of a multistage supply pump used in the clean-in-place unit of FIG. 1;

FIG. 4 is a simplified fragmentary schematic illustration depicting the construction of a single stage return pump used in the clean-in-place unit of FIG. 1; and

FIG. 5 is an illustrative schematic graph depicting an output signal from a microphone or acoustic sensor which senses changes in sound generated during cleaning of the processing equipment illustrated schematically in FIG. 1.

### DESCRIPTION OF SPECIFIC PREFERRED EMBODIMENTS OF THE INVENTION

### General Description

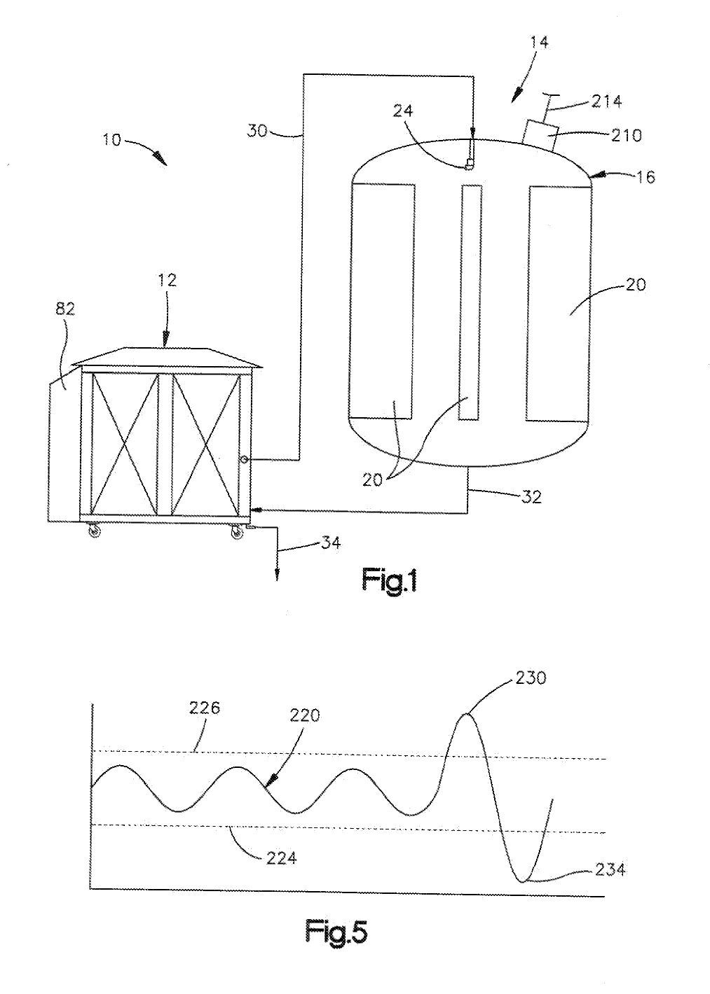

An apparatus 10 is illustrated in FIG. 1. The apparatus 10 includes cleaning equipment, that is, a clean-in-place unit 12, which is constructed and operated in accordance with the present invention. The clean-in-place unit 12 may be utilized to clean any known type processing equipment 14. The processing equipment 14 may be utilized in the dairy, beverage, brewing, pharmaceutical, food preparation, or cosmetic industries. Of course, the clean-in-place unit 12 may be utilized to clean processing equipment 14 used in other industries.

The illustrated processing equipment 14 includes a vessel or receptacle 16. However, the processing equipment 14 could be a pipe line which holds and/or conveys material. Alternatively, the processing equipment 14 may be a machine or other device which receives material.

During use of the processing equipment 14, the receptacle 16 receives material to be processed. Of course, the receptacle 16 could hold other materials if desired. The receptacle 16 may have any desired construction. For example, the receptacle 16 may be formed by one or more pipes. As another example, the receptacle 16 may be formed by one or more machines which are used to process material. The receptacle 16 may be any device which receives material which may or may not be processed.

The processing equipment 14 may take anyone of many different forms other than the receptacle 16. The processing equipment 14 may, for example, include machines and/or conduits. It should be understood that the receptacle 16 is merely representative of many known types of material receiving equipment and/or components of material receiving equipment. The material received by the receptacle 16 may only be stored in the receptacle.

The vessel or receptacle 16 (FIG. 1) encloses baffles 20 which engage material in the receptacle during use of the processing equipment 14. Although the baffles 20 have been illustrated as having a generally rectangular configuration, it is contemplated that the baffles may have a different configuration. For example, the baffles 20 may have a helical configuration. In addition to baffles 20, the receptacle 16 may contain mixers and/or other devices for use in processing material. Alternatively, the receptacle 16 may not contain baffles and/or other devices.

When the clean-in-place unit 12 is to be utilized to clean processing equipment 14, represented by the receptacle 16, the processing equipment is emptied, to the extent possible, of material which was held in the processing equipment during use of the processing equipment. It should be understood that the processing equipment 14 may or may not include a plurality of receptacles 16, pipes, machines, and/or other devices which are used in the processing of material.

Before the clean-in-place unit 12 is utilized, suitable cleaning solvents are selected. The cleaning solvent may be anything which promotes dispersing and/or dissolving of material in the receptacle. The solvent may promote the formation of a mixture and/or a solution.

The cleaning solvent may be a type of water, such as city water, softened water, reverse osmosis water, USP purified water, or water for injection. The cleaning solvent may include a detergent or other cleaning agent, such as methanol, isoproponal, alcohol, etc. The detergent, if any, in a specific cleaning solvent may be either an alkaline or acidic detergent. The detergent may contain a surfactant to penetrate or cut grease and to wet surfaces. An oxidant may be provided in the cleaning solvent. Enzymes may be provided in the cleaning solvent. The cleaning solvent is mixed with water to obtain a cleaning solution having the desired concentration of the detergent and its various components.

Based on the composition of the material which is received in the processing equipment and the selected cleaning solvent, a cleaning solution temperature is selected. The cleaning solution temperature may be at a temperature of between 10 and 95 degrees Centigrade. The specific temperature which is selected will depend upon the composition of the cleaning solution, the composition of residues in the receptacle 16, and on the arrangement of surfaces within the receptacle. The cleaning solution may be a single liquid or a mixture of liquids which may or may not be homogeneous.

A selected cleaning solution dispensing device 24 is disposed in the receptacle 16. While static cleaning solution dispensing devices, such as non-rotating ball type dispensing devices, may be used, it is believed that it may be desired to have a dynamic cleaning solution dispensing device, such as a rotary nozzle. It is believed that cleaning efficiency/effectiveness is better with dynamic cleaning solution dispensing devices than static cleaning solution dispensing devices If desired, the dynamic cleaning solution dispensing device may rotate about one or more axes. For example, a dynamic cleaning solution dispensing device 24 may rotate about both a vertical axis and horizontal axis while dispensing the cleaning solution.

A combination of static and dynamic cleaning solution dispensing devices 24 may be used. If desired only static cleaning solution dispensing devices 24 may be used. Alternatively, only dynamic cleaning solution dispensing devices 24 may be used.

The placement and construction of the selected dispensing devices 24 will depend upon the construction of the processing equipment 14. The selection of the dispensing device or devices 24 will also be affected by the material in the processing equipment and the composition of the cleaning solution. It should be understood that static and/or dynamic dispensing devices 24 may be used.

It is contemplated that the cleaning solution dispensing device or devices 24 may be a rotary cleaning solution dispensing device having a construction which is similar to the construction of the cleaning solution dispensing devices disclosed in U.S. Pat. Nos. 6,123,271; 6,460,553; 6,561,199; and/or 7,507,298. Rotary spray heads and jet heads are commercially available from Toftejorg which has a representative place of business at 2700 Partnership Boulevard, Springfield, Mo. 65803. Of course, other types of cleaning solution dispensing devices may be utilized if desired.

Although only a single cleaning solution dispensing device 24 is illustrated schematically in FIG. 1, it should be understood that a plurality of cleaning solution dispensing devices may be provided in association with the receptacle 16. Although the illustrated dispensing device 24 is shown as being mounted adjacent to an upper end portion of the receptacle 16, it is contemplated that the cleaning solution dispensing device may be positioned a substantial distance below the upper end portion of the receptacle on a shaft which conducts the cleaning solution to the dispensing device. Of course, cleaning solution dispensing devices may be mounted in any desired manner and may be disposed at several different levels in the receptacle 16.

The specific arrangement which is selected for the dynamic cleaning solution dispensing devices and/or static cleaning solution dispensing devices 24 in the receptacle 16 will depend, in part at least, on the arrangement of surfaces to be cleaned in the receptacle and/or the residues to be removed. Thus, if baffles 20 having helical or arcuately curving configurations are disposed within the receptacle 20, one arrangement of cleaning solution dispensing devices 24 may be selected. However, if there are no baffles or a different arrangement of baffles, a different arrangement of cleaning solution dispensing devices 24 may be provided in the receptacle 16. As was previously mentioned, the receptacle 16 should be considered as merely being representative of any one of many known types of material receiving equipment. The tenacity with which residues of the material held in the receptacle 16 adhere to surfaces within the receptacle will, in part at least, determine the type and positioning of cleaning solution dispensing devices 24 within the receptacle, and the mode of operation of the cleaning solution dispensing devices.

The cleaning action which is obtained with the cleaning solution dispensing device or devices 24 in the receptacle 16 will depend, in part at least, on the pressure and rates at which the cleaning solution is dispensed. The clean-in-place unit or cleaning equipment 12 supplies the dispensing devices 24 in the receptacle 16 with cleaning solutions at pressures between 60 and 250 pounds per square inch (gauge) and at a flow rate of between 10 and 125 gallons per minute (gpm). Of course, the specific pressures and flow rates at which cleaning solution is dispensed from the dispensing devices 24 in the receptacle 16 will depend upon the construction of the dispensing devices and/or the composition of the material forming the residue in the receptacle and the arrangement of surfaces within the receptacle. Generally speaking, dynamic cleaning solution dispensing devices 24 may operate at higher pressures than static cleaning solution dispensing devices. However, static cleaning solution dispensing devices may operate at higher flow rates than dynamic cleaning solution dispensing devices. The pressures and/or flow rates at which cleaning solution is dispensed may be different than the aforementioned pressures and flow rates.

The cleaning action which is obtained in the receptacle 16 will depend on the composition and temperature of the cleaning solution, location and arrangement of the static and/or dynamic cleaning solution dispensing device or devices 24, and the pressure and flow rate at which the cleaning solution is dispensed from the dispensing devices 24. Of course, the total cleaning action will be affected by the period of time for which cleaning solution is dispensed from the cleaning solution dispensing devices 24.

The cleaning solution is supplied to one or more dispensing devices 24 in the receptacle 16 through a cleaning solution supply conduit 30. Cleaning solution is returned from the receptacle 16 to the clean-in-place unit or cleaning equipment 12 through a cleaning solution return conduit 32. The cleaning solution conducted through the return conduit maybe a liquid or a mixture of liquids in which solid material is entrained and/or dissolved. Cleaning solution is conducted from the cleaning equipment to drain or other receiving location through a drain conduit 34.

Although only a single cleaning solution supply conduit 30 is illustrated, a plurality of cleaning solution supply conduits may be utilized. These cleaning solution supply conduits 30 may be connected to the same receptacle 16 or may be connected to a plurality of receptacles. Similarly, although only a single cleaning solution return conduit 32 is illustrated, a plurality of cleaning solution return conduits may be utilized. These cleaning solution return conduits may be connected to the same receptacle 16 or may be connected to a plurality of receptacles.

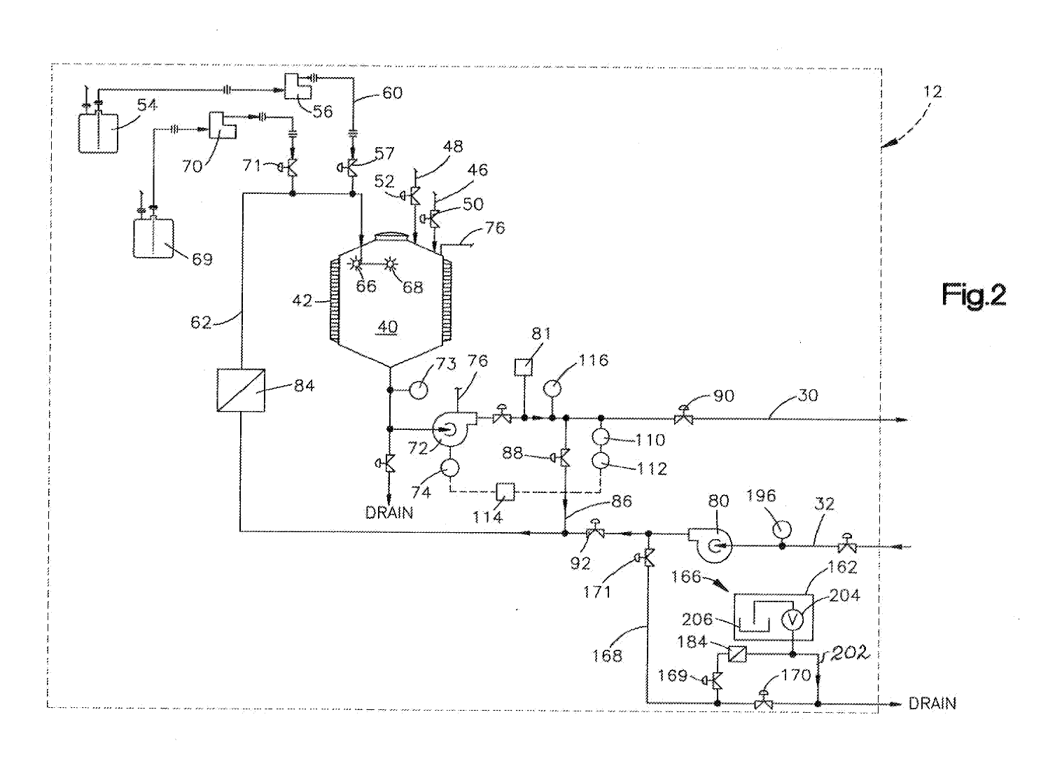

The general construction of the clean-in-place unit or cleaning equipment 12 is illustrated schematically in FIG. 2. The clean-in-place unit 12 includes a tank 40 which holds a supply of cleaning solution to be conducted through the cleaning solution supply conduit 30 to the receptacle 16. The cleaning solution may be a homogeneous mixture. Alternatively, the cleaning solution may be a mixture which is not homogeneous.

A suitable heater is provided to heat the contents of the tank 40. The tank 40 has insulation 42 which limits heat transfer to the surrounding environment. This tends to minimize the energy required to heat the cleaning solution to a desired temperature and to maintain the cleaning solution at the desired temperature. If desired, the heater may be omitted.

Water is supplied to the tank 40. Any known type of water may be supplied to the tank 40. The water supplied to the tank 40 may be city water, softened water, reverse osmosis water, USP purified water, and/or USP water for injection. However, it is believed that it may be preferred to use only one type of water in the tank at a time. It is also believed that water of a lesser quality/purity may be supplied to the tank 40 for pre-rinse steps and at least some wash steps. It is also believed that it may be desired to supply water of a higher quality to the tank 40 for one or more final rinses.

USP water for injection (WFI) or sterile water is supplied to the tank 40 through a conduit 46. USP purified water, that is, water which has been processed to remove impurities, is supplied through a purified water conduit 48. Only one type of water, that is, either water for injection or USP purified water, is used in a batch of cleaning solution in the tank. USP purified water may be used for pre-rinse steps in a cleaning process. USP water for injection (WFI) may be used for final rinse steps in the cleaning process. Suitable valves 50 and 52 are provided to control water flow through the conduits 46 and 48.

A cleaning solvent measuring tank 54 holds cleaning solvent. A desired amount of cleaning solvent is pumped from the cleaning solvent measuring tank 54 by a pump 56. A suitable valve 57 controls flow through the conduit 60. The cleaning solvent may be anything which promotes the dispersing and/or dissolving of material and/or residues disposed in the processing equipment 14. The valve 57 is closed, except when the pump 56 is to be operated.

The fixed displacement pump 56 may be operated through a predetermined number of operating cycles to pump the desired volume cleaning solvent. Alternatively, the pump 56 may be operated until a load cell under the tank 54 indicates that a desired weight of cleaning solvent has been pumped. The concentration of cleaning solvent in the cleaning solution may be confirmed by measuring the electrical conductivity of the cleaning solution.

A pre-defined amount (batch) of cleaning solvent is pumped from the container 54 through conduits 60 and 62. At this time, the valve 57 is open. The solvent is mixed with water and/or other liquid which is already disposed in the tank 40. The amount of solvent which is pumped from the container 54 may be measured by operating the fixed displacement pump 56 through a predetermined number of operating cycles. This may be accomplished by operating the pump 56 for a predetermined period of time. Alternatively, controls may be provided to detect and count each operating cycle of the pump 56. Alternatively, a specified weight of cleaning solvent, corresponding to the desired amount of cleaning solvent, may be pumped from the container 54. In addition, the composition of the cleaning solution in the tank 40 may be confirmed by sensing the electrical conductivity in the liquid in the tank. When operation of the pump 56 is interrupted, the valve 57 is closed. The cleaning solvent flows to the tank 40 through conduits 60 and 62.

The cleaning solvent is distributed in the tank 40 through static spray balls 66 and 68 and mixed with water and/or other liquids to form a cleaning solution. Of course, the cleaning solvent could be distributed in a different manner if desired.

If desired, a solvent storage tank (not shown) may be provided to hold a substantial supply of cleaning solvent. If this is done, a supply pump would be connected in fluid communication with the solvent storage tank and the solvent measuring tank 54.

When a plurality of cleaning solvents are to be utilized in the cleaning solution, a plurality of cleaning solvent measuring tanks and pumps, corresponding to the measuring tank 54 and pump 56, may be provided. The number and type of cleaning solvents utilized will, in part at least, depend upon the composition of the material received in the receptacle 16. Thus, a second solvent measuring tank 69 holds a cleaning solvent which is different than the solvent held by the measuring tank 54. A pump 70 is operable to pump solvent from the measuring tank 69 to the tank 40. A suitable valve 71 controls flow from the pump 70. The valve 71 is closed, except when the pump 71 is to be operated.

The cleaning solution is conducted from the tank 40 through a portion of the cleaning solution supply conduit 30 connected to the lower end of the tank. A flow of cleaning solution is conducted, under the influence of gravity, through the conduit 30 to the suction side of a supply pump 72. This results in the supply pump 72 operating without cavitation.

The cleaning solution may contain one or more solvents, such as a detergent. Alternatively, the cleaning solution may be free of solvent from the tanks 54 and/or 59. For example, the cleaning solution may be a rinse water. A conductivity sensor 73 is provided to monitor the electrical conductivity of cleaning solution conducted from the tank 40 to the cleaning solution supply conduit 30.

In accordance with one of the features of the present invention, the supply pump 72 is a multistage pump which is driven by a variable speed motor 74 to obtain a desired fluid pressure in the cleaning solution supply conduit 30 downstream from the supply pump. The supply pump 72 discharges a continuous stream of cleaning solution when the supply pump is being driven by the motor 74. The cleaning solution is discharged from the supply pump 72 at a desired pressure.

In one specific embodiment of the invention, the supply pump 72 was a multistage pump which was operable to discharge cleaning solution at a pressure in a range of between approximately 60 and 250 psi (gauge) and at a flow rate of between 10 gallons per minute and 125 gallons per minute. Of course, the pump 72 may discharge cleaning solution at pressures and/or flow rates which are different than these specific pressures and flow rates. To enable the pump 72 to supply a continuous stream of liquid cleaning solution to the cleaning solution supply conduit 30, the pump 72 is vented back to the tank 40 through a vent conduit 76.

Cleaning solution is actively removed from the receptacle 16 (FIG. 1) by a return pump 80 (FIG. 2). The return pump 80 is a single stage pump that is capable of operating with water and with a mixture of air and water. The return pump 80 is capable of pumping cleaning solution containing particles of material removed from the receptacle 16.

The return pump is driven by an electric motor to rotate a single impeller and pump liquid with entrained gasses to a portion of the return conduit 32 disposed downstream from the return pump 80. Returned cleaning solution can be directed to either drain or back to the tank 40. The returned cleaning solution may contain a cleaning agent or may be a rinse liquid. The returned cleaning solution may contain dissolved material from the receptacle 16. The returned cleaning solution may contain particles of material removed from the receptacle 16. The returned cleaning solution may contain both dissolved material from the receptacle 16 and particles of material from the receptacle.

When the receptacle 16 has been cleaned, a gas purge system 81 may be connected with the supply conduit 30 to purge the clean-in-place unit 12 and/or processing equipment 14 of any remaining liquid. The gas purge system 81 directs a flow of air or other gas under pressure into the supply conduit. The various valves in the processing equipment 14 are operated to direct the flow of pressurized purge gas through the various dispensing devices 24, pumps, conduits and other devices in the processing equipment. In addition, the purge gas may be conducted through the various pumps, conduits and other devices in the clean-in-place unit 12.

The flow of gas from the gas purge system 81 is directed through the supply conduit 30 to the dispensing device 24 to blow any remaining cleaning solution out of the dispensing device. The flow of gas from the gas purge system is also directed through the recirculate conduit 86 to the return conduit 32 and the conduit 62 connected with the static spray balls 66 and 68. This enables any remaining cleaning solution to be blown out of the static spray balls 66 and 68.

In addition, the flow of gas from the gas purge system 81 may be directed through the multistage supply pump 72 to blow any remaining cleaning solution out of the supply pump. The flow of purge gas may be conducted to the tank 40 through the supply conduit 30 and/or vent conduit 76. Of course, the flow of purge gas may also be directed through the return pump 80.

The gas purge system can be activated between wash and rinse steps and/or after the final rinse. For example, when the gas purge is performed after the first (caustic) wash, the amount of water required during the following rinse step is minimized. As another example, when the gas purge is performed after the final rinse, it is possible to remove all droplets of the final rinse solution from the processing equipment 14 to eliminate or at least reduce the risk of microbial growth.

The program which is followed by the clean-in-place unit 12 will depend upon the cleaning requirements for the specific processing equipment 14 being cleaned. Different types of processing equipment 14 will have different cleaning programs. The clean-in-place unit 12 has controls 82 (FIG. 1) which can be set to accommodate cleaning programs for the cleaning of many different types of processing equipment 14.

Generally speaking, the usual cleaning program may include a pre-rinse, post rinse, caustic wash, post rinse, acidic wash, post rinse, and a final rinse. However, the controls 82 enable the cleaning program to be modified to accommodate the cleaning programs for many different types of processing equipment 14 which are used to process many different types of materials. The specific cleaning program utilized will depend on the specific processing equipment 14 and material which the processing equipment is used to process.

The initial pre-rinse is almost always performed as a once through operation (direct to drain) because the return cleaning solution is highly contaminated. The return cleaning solution from the initial pre-rinse is directed from the return pump 80 to drain. The cleaning solution returned from the pre-rinse will contain a substantial amount of the residue from the tank 16. In addition to residue, air and/or other gas will probably be entrained in the cleaning solution returned from the pre-rinse by operation of the single stage return pump 80.

After the pre-rinse and until the final rinse, the various steps of the cleaning program may be performed in either a recirculation or once through mode for utilization of cleaning solution. If a recirculation mode is to be used, the returned cleaning solution and any entrained gases and/or particulate are conducted from the return pump 80 to the tank 40 in the clean-in-place unit 12. If the once through mode is be used, the returned cleaning solution and any entrained gases and/or particulate are conducted from the return pump 80 to drain.

The cleaning solution may, depending upon the selected cleaning program, be returned to the tank 40 in the clean-in-place unit 12 during cleaning cycles other than the pre-rinse cycle and final rinse cycle. Therefore, the composition of the cleaning solution contained in the tank 40 may vary during portions of the cleaning program other than the pre-rinse and final rinse cycles. During the pre-rinse and final rinse cycles of the cleaning program, the cleaning solution may be used on a once through basis. During use of cleaning solution on a once through basis, there is no return of cleaning solution in the tank 40.

Monitoring of the composition of the cleaning solution in the tank 40 may be conducted using known methods, including electrical conductivity or hydrogen ion (pH) sensing. It should be understood that the level of the cleaning solution in the tank 40 is continuously monitored.

The return conduit 32 is connected to a heat exchanger 84. In recirculation mode, the cleaning solution returned by the return pump 80 through the conduit 32 is conducted through the heat exchanger 84. The heat exchanger 84 is effective to adjust (maintain) the cleaning solution to a desired temperature. The cleaning solution is conducted, at the desired temperature, from the heat exchanger 84 through the conduit 62 to the tank 40.

It is contemplated that the return cleaning solution may be maintained at a temperature of between 10 and 95 degrees Centigrade by a flow of liquid at a higher temperature into the heat exchanger 84. The used cleaning solution is then conducted from the heat exchanger 84 through the conduit 62 back to the tank 40. When cleaning solution is being conducted from the heat exchanger to the tank 40, the valves 57 and 71 are closed.

When liquid, such as cleaning solvent and/or water, is added to the tank 40, it is desirable to have a uniform composition and temperature throughout the liquid held by the tank 40. To enable this to be accomplished, a recirculate conduit 86 (FIG. 2) is provided. The degree of homogeneity required for the cleaning solution will depend, in part at least, on the material received in the processing equipment 14 and/or the purpose for which the material received in the processing equipment is used.

When liquid in the tank 40, such as cleaning solvent and/or water, is to be recirculated to obtain uniform temperature and/or composition, a valve 88 (FIG. 2) at the entrance to the recirculate conduit 86 is opened. At the same time, a valve 90 in the supply conduit 30 downstream from the connection with the recirculate conduit 86 is closed. In addition, a valve 92 is disposed in the return conduit 32 between the return pump 80 and the outlet from the recirculate conduit 86 is closed.

This enables the supply pump 72 to be operated to induce a flow of liquid from the tank 40 through the recirculate conduit 86 to the return conduit 32. This flow of liquid is conducted through the heat exchanger 84 and conduit 62 to the static spray balls 66 and 68 in the tank 40. Recirculation of the cleaning solution is continued until the cleaning solution has the desired degree of homogeneity. The cleaning solution which is recirculated may contain just water or may contain a mixture of water and cleaning solvent. The cleaning solution which is recirculated may also contain cleaning solution returned from the processing equipment 14.

The aforementioned flow of liquid from the tank 40 through the recirculation conduit 86 to the return conduit 32 is conducted through the heat exchanger 84. The heat exchanger 84 is effective to heat the recirculating liquid to, and to maintain the recirculating liquid at a desired temperature which is between 10 and 95 degrees Centigrade. If desired, the heat exchanger 84 may be located in the tank 40. Temperature sensor 116 senses the temperature of the recirculating liquid.

By recirculating the liquid from the tank 40 through the heat exchanger 84 and static spray balls 66 and 68 in the tank, a homogeneous body of liquid (cleaning solution) is obtained in the tank 40. This homogeneous body of liquid will have a uniform temperature and composition throughout the body of liquid. This enables the temperature of the liquid (cleaning solution) to be adjusted internally of the clean-in-place unit 12 before the liquid is conducted to the processing equipment 14. If desired, the recirculation function and conduit 86 may be omitted.

### Cleaning Solution Supply

Cleaning solution is conducted from the cleaning equipment 12 (FIGS. 1 and 2) to the receptacle 16 in the processing equipment 14 (FIG. 1). The multistage cleaning solution supply pump 72 (FIG. 2) is driven by a variable speed electric motor 74 to discharge cleaning solution at a pressure of 60 pounds per square inch gauge (psig) to 250 pounds per square inch gauge (psig). The supply pump 72 may be operated to discharge cleaning solution at pressures other than the specific pressures set for the herein. A pressure sensor 110 is exposed to the fluid pressure in the cleaning solution supply conduit 30 at a location downstream from the supply pump 72.

A transmitter 112 (FIG. 2) is connected with the pressure sensor 110 and with a controller 114. The transmitter 112 sends a signal to the controller 114. This signal is of a magnitude which varies as a function of variations in the pressure detected by the pressure sensor 110. The controller 114 varies the speed of operation of the electric motor 74 and the speed of operation of the multistage supply pump 72 as a function of the signal from the transmitter 112. This enables the supply pump 72 to maintain a desired fluid pressure in the cleaning solution supply conduit 30. The transmitter 112 and controller 114 enable the motor 74 to quickly change the operating speed of the supply pump 72 to adjust to changes in line and/or dispensing device condition.

The speed of operation of the multistage supply pump 72 is varied to maintain a predetermined pressure in the cleaning solution supply conduit 30. A temperature sensor 116 senses the temperature of the cleaning solution in the supply conduit 30. Therefore, the fluid pressure and temperature at which cleaning solution is supplied to one or more cleaning solution dispensing device 24 (FIG. 1) in one or more receptacles 16 of the processing equipment 14 are at desired values.

Since the desired fluid pressure (and thereby flow rate) is maintained in the cleaning solution supplied to the dispensing device 24, the force with which the streams of cleaning liquid from the cleaning solution dispensing device 24 impact against residues in the receptacle 16 is predictable and repeatable to obtain a desired cleaning action. As was previously mentioned, the cleaning solution dispensing device 24 may include a plurality of static and/or dynamic dispensing devices. Each of the dynamic dispensing devices 24 requires a supply of cleaning solution at specific pressures and flow rates in order to optimize operational function and efficiency.

Although many different types of dispensing devices 24 may be utilized, it is believed to be advantageous to use a rotary dispensing device which has nozzles that are rotatable relative to the receptacle 16 about one or more axes. The cleaning solution dispensing device 24 may have nozzles which are rotatable about two axes which extend substantially perpendicular to each other. One of the axes may be a horizontal axis and the other one may be a vertical axis. However, the dispensing nozzles may rotate about axes which are skewed relative to horizontal and vertical axes if desired.

Although only one dispensing device 24 is illustrated, a plurality of dispensing devices may be utilized. If a plurality of dispensing devices 24 are used, one or more of the dispensing devices may have a construction other than a rotary construction. For example, static nozzles or spray balls may be used either with or without a rotary dispensing device.

The pressure at which cleaning solution is conducted to the dispensing device 24 will depend, at least in part, on the type of spray device and the arrangement of surfaces in the receptacle 16 from which residues are to be removed by the cleaning action of the jets of cleaning solution from the dispensing device. In addition, the pressure at which cleaning solution is supplied to the dispensing device 24 is determined as a function of the composition of the material forming the residue which is to be removed from the surfaces of the receptacle 16 by the cleaning action. Since the controller 114 effects operation of the motor 74 to drive the supply pump 72 to maintain a substantially constant pressure in the cleaning solution supply conduit 30, the force with which the jets of cleaning solution are dispensed from the dispensing device 24 is maintained substantially constant throughout cleaning of the receptacle 16.

The cleaning solution supply pump 72 is a multistage pump. Therefore, the pump 72 has a plurality of impellers which are disposed in a coaxial relationship and are driven by the motor 74. By having a plurality of impellers or stages, the pump 72 can be utilized to supply cleaning solution to the supply conduit 30 at any desired pressure within a substantial range of pressures. The relatively high pressure at which cleaning solution is supplied by the multistage pump can overcome back pressure in lines and from spray devices. The higher pressures allow the use of dynamic spray devices 24. The multistage pump 72 can operate at relatively high temperatures without cavitation. The supply pump 72 may be utilized to supply cleaning solution to the supply conduit at pressures between 60 pounds per square inch (gauge) and 250 pounds per square inch (gauge). Of course, the cleaning solution may be supplied at other pressures if desired.

If the pressure sensor 110 detects that the pressure in the cleaning solution supply conduit is slightly below a desired pressure, the controller 114 effects operation of the motor 74 to increase the speed at which the multistage supply pump 72 is driven. This results in an increase in the cleaning solution pressure in the supply conduit 30. Similarly, if the pressure sensor 110 detects that the pressure of the cleaning solution in the supply conduit 30 is above a predetermined pressure, the controller 114 decreases the speed of operation of the motor 74 to decrease the speed at which the pump 72 is driven. This results in a decrease in the fluid pressure in the cleaning solution supply conduit 30.

The combination of the pressure sensor 110, controller 114 and variable speed electric motor 74 enables the multistage pump 72 to be operated to effectively and rapidly obtain and maintain a substantially constant fluid pressure and flow rate in the cleaning solution supply conduit 30 over a large range of cleaning solution flow rates and pressures. Motor 74 drives the multistage supply pump 72 to maintain a desired cleaning solution pressure in the supply conduit 30. This pressure may be between 60 pounds per square inch (gauge) and 250 pounds per square inch (gauge). In addition, a desired cleaning solution flow rate is maintained in the supply conduit 30. This flow rate may be between 10 gallons per minute and 125 gallons per minute.

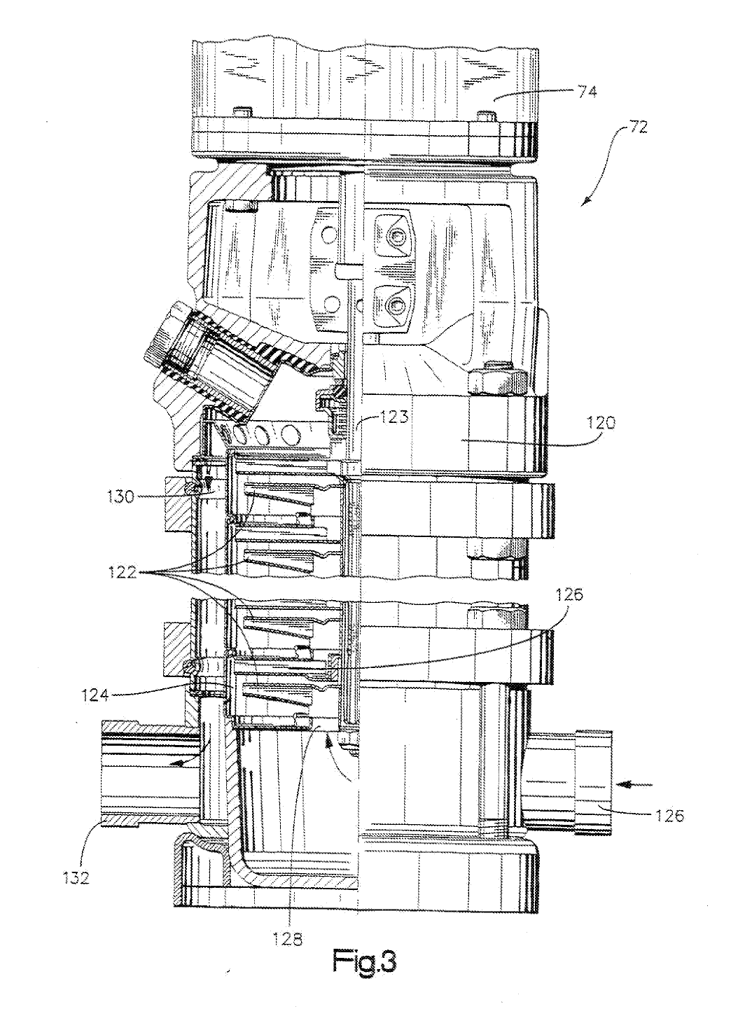

The cleaning solution supply pump 72 (FIG. 3) includes a housing 120 which encloses a plurality of circular impellers 122 which are fixedly secured to a central drive shaft 123. The drive shaft 123 is driven by the motor 74.

Cleaning solution enters the pump housing 72 at an inlet 126. The cleaning solution flows through a central suction opening 128 to the first or lower (as viewed in FIG. 3) stage of the multistage cleaning solution supply pump 72. The rotating first or lower one of the impellers 122 accelerates the cleaning solution and causes it to flow radially outwardly to the periphery of the first or lower impeller 122.

The cleaning solution flows from the periphery of the lower impeller 122 into a circular space 124 which extends around the lower impeller. The cleaning solution then flows into a passage 126 which is connected in fluid communication with a radially inner portion of the next succeeding stage or impeller 122. As the cleaning solution sequentially moves from one stage of the supply pump 72 to the next succeeding stage, the pressure of the cleaning solution is increased by the pumping action of the impellers 122.

Relatively high pressure cleaning solution flows from the uppermost stage or impeller 122 of the multistage supply pump 72 into an annular outlet chamber 130. The outlet chamber 130 is connected in fluid communication with an outlet 132 from the multistage supply pump 72. The outlet 132 is connected in fluid communication with the cleaning solution supply conduit 30.

The general construction and mode of operation of the cleaning solution supply pump 72 is similar to that disclosed in U.S. Pat. Nos. 4,842,480 and 4,877,372. Although these patents show pumps having a vertical arrangement of impellers, a cleaning solution supply pump 72 having a horizontal arrangement of impellers may be utilized if desired. Suitable multistage pumps which may be used for the cleaning solution supply pump 72 are commercially available from Grundfos Pumps Corporation having a place of business at 17100 West 118^{th} Terrace, Olathe, Kans. 66061. However, it should be understood that suitable multistage cleaning solution supply pumps may be obtained from commercial sources other than Grundfos Pumps Corporation.

Used cleaning solution is returned from the receptacle 16 (FIG. 1) to the cleaning equipment 12 through the cleaning solution return conduit 32. The cleaning solution return conduit 32 is connected with the lower end portion of the receptacle 16 in the processing equipment 14. Therefore, used cleaning solution flows from the receptacle 16 into the return conduit 32 under the influence of gravity.

In the cleaning equipment 12, at a level below a lower end portion of the receptacle 16, the return conduit 32 is connected with a return pump 80 (FIG. 2). The return pump 80 is operable to pump a mixture of cleaning solution and entrained gas (air) to either drain (once through mode) or to the heat exchanger 84 (recirculation mode). When the returned cleaning solution is returned (recirculated) in the clean-in-place unit 12 via return conduit 32, the temperature of the cleaning solution is maintained at the specified temperature using the heat exchanger 84. The returned cleaning solution will enter tank 40 through static spray balls 66 and 68. The returned cleaning solution may or may not contain solvent from one of the measuring tanks 54 or 69. The returned cleaning solution may or may not contain particulate from the processing equipment 14.

The used cleaning solution is mixed with cleaning solution held in the tank 40. The resulting mixture of used and unused cleaning solution is pumped from the tank 40 by the supply pump 72 to the cleaning agent dispensing device 24 in the receptacle 16 in the manner previously explained. Alternatively, the used cleaning solution may be conducted directly from the return pump 80 to drain.

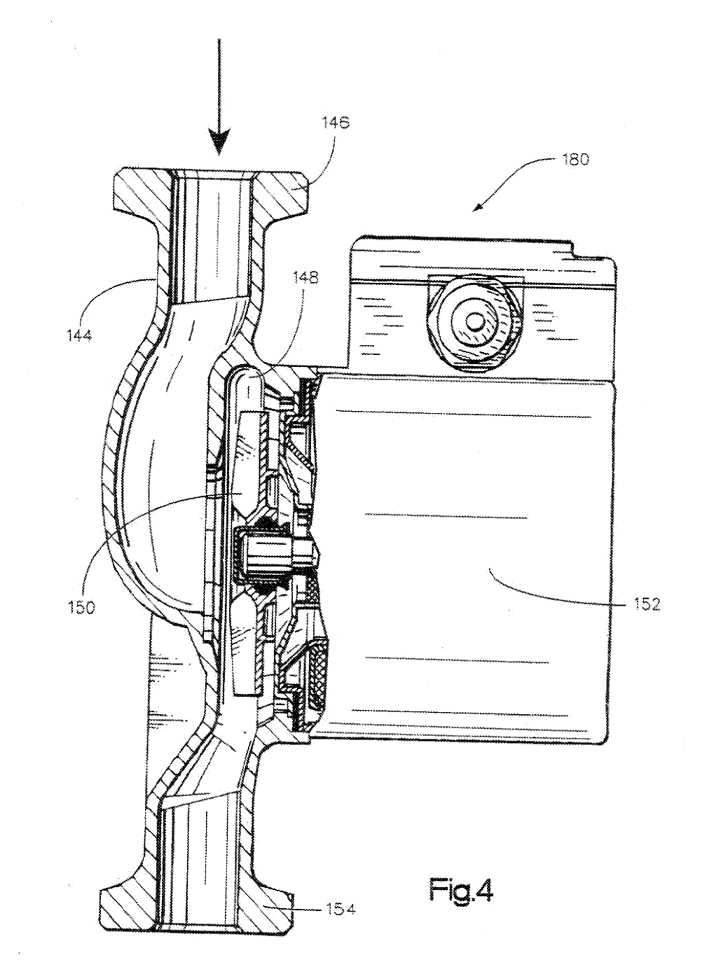

The return pump 80 is a single stage pump. The return pump 80 (FIG. 4) includes a housing 144 having an inlet 146. The inlet 146 is connected with the return conduit 32 and receives used cleaning solution returned from the receptacle 16 of FIG. 1. This used cleaning solution may include entrained gas, such as air. The used cleaning solution may include dissolved material from the processing equipment 14. The used cleaning solution may include particles of material from the processing equipment 14.

The used cleaning solution flows into a pumping chamber 148 containing a single circular impeller 150. The impeller 150 is driven by a motor 152. Additionally, the impeller 150 causes the returned cleaning solution to be pumped from the chamber 148 to an outlet 154 from the housing 144. The return pump 80 is a single stage pump in that it only has a single impeller.

The general construction of the return pump 80 is the same as disclosed in U.S. Pat. Nos. 5,356,266 and 6,746,206. Suitable return pumps 80 are commercially available from Hilge International (a Grundfos Company) having a place of business at Grundfos Pumps Corporation 17100 West 118^{th} Terrace, Olathe, Kans. 66061. Of course there are other commercial sources of suitable single stage return pumps.

The level of cleaning solution in the tank 40 (FIG. 2) is continuously sensed. One or more of many known types of sensors may be used to sense the level of cleaning solution in the tank 40. For example, a pressure sensor that is disposed at the bottom of a column of liquid in the tank 40 may be utilized. As another example, a microwave emitter (radar) may be used to sense the level of liquid in the tank 40.

### Total Organic Carbon

A total organic carbon analyzer 162 (FIG. 2) is utilized to verify inline/in situ that the processing equipment 14 has been cleaned correctly, according to predefined acceptance criteria, using the clean-in-place unit 12. The total organic carbon analyzer 162 senses the amount of organic carbon in the used cleaning solution. The use of the total organic carbon analyzer 162 enables rapid determination of when the processing equipment 14 has been completely cleaned. This enables processing equipment 14 to be returned to production more rapidly and efficiently and with greater reliability.

The total organic carbon analyzer 162 senses the concentration of organic carbon contained in the cleaning solution by first sensing the concentration of electrically conductive inorganic carbon in the cleaning solution. The organic carbon in the cleaning solution is then processed to be electrically conductive. This enables the total concentration of carbon, that is, both organic and inorganic, to be sensed. The concentration of just organic carbon is determined by subtracting the concentration of inorganic carbon from the total concentration of carbon. If desired, the concentration of organic carbon in the cleaning solution may be sensed in a different manner.

Although the total organic carbon analyzer (sensor) 162 may be used at other times in the cleaning program, it is believed that it may be desired to use the total organic carbon analyzer at the end portion of the final rinse cycle. The output from the total organic carbon analyzer 162 will clearly and positively indicate that the use of the cleaning equipment 12 has resulted in a cleaning of the processing equipment 14 to the desired degree of cleanliness. By preserving a record of the output from the total carbon analyzer 162, there is a written or electronic batch record which proves that the equipment was cleaned to the required extent after the processing of one batch with the equipment 14 and prior to processing of a next succeeding batch.

The total carbon analyzer 162 is disposed in a carbon sensing section 166 which is connected with the return conduit 32 and the return pump 80 by a drain conduit 168 and analyzer valve 169. When the carbon content of the cleaning solution returned from the processing equipment 14 through the return conduit 32 is not to be sensed, a drain valve 170 is in an open condition and the analyzer valve 169 is closed. This results in the return cleaning solution being conducted to drain. Alternatively, a valve 171 may be closed and the valve 92 opened to enable the cleaning solution returned from the processing equipment 14 to be conducted to the tank 40 and recirculated.

It is contemplated that the concentration of organic carbon in the returned cleaning solution will be determined toward the end of the final rinse cleaning cycle. However, the concentration of organic carbon can be determined at other times if desired. When it is desired to determine the concentration of organic carbon in cleaning solution being returned from the processing equipment 14 through the return conduit 32, during the final rinse cleaning cycle, the analyzer valve 169 is opened. At this time, the recirculate valve 92 and drain valve 170 are closed. However, the valves 171 and 169 are open. This enables used cleaning solution to continuously flow from the return conduit 32 and drain conduit 168 into the carbon sensing section 166. Cleaning solution flows from the carbon sensing section 166 to drain.

In order to accurately determined concentration of organic carbon in the return cleaning solution, which may be from the final rinse cycle, it is necessary to have the used cleaning solution at a temperature which is less than eighty-five degrees Centigrade (85°. To cool the used cleaning solution to a temperature less than eighty-five degrees Centigrade, a heat exchanger 184 is provided in the carbon sensing section 166. However, when it is not necessary to cool the return cleaning solution, the heat exchanger 184 may be omitted or bypassed. If desired the heat exchanger 184 may be located in the conduit 168 ahead of the analyzer valve 169.

When the used cleaning solution is relatively hot, that is, at a temperature of 85° C. or more, the heat exchanger 184 may be utilized to cool the cleaning solution. When this is to be done, a flow of cooling liquid is conducted through the heat exchanger 184. When the cleaning solution leaves the heat exchanger 184, it will be at a temperature which is suitable for analysis by the total organic carbon analyzer 162.

It should be understood that the specific temperature to which the returned cleaning solution is cooled in the heat exchanger 184 will depend upon the operating characteristics of the total organic carbon analyzer 162 and may be different than the aforementioned temperature of eighty-five degrees Centigrade or less. Total organic carbon analyzers having operating characteristics and/or requirements that are different from the operating characteristics and/or requirements of the total organic carbon analyzer 162 may be utilized in the carbon sensing section 166. For example, the operating characteristics of the total organic carbon analyzer 162 may be such as to enable the heat exchanger 184 to be eliminated. In some situations, the temperature of the returned cleaning solution may be low enough to enable the heat exchanger 184 to be eliminated or bypassed.

A valve 204 in the total organic carbon analyzer 162 is then opened for a short period of time to enable a sample of the cleaning solution to be conducted into the total organic carbon analyzer 162 through an inlet conduit. When a sample bottle or container 206 in the total organic carbon analyzer 162 is filled with cleaning solution, the valve 204 is closed stopping flow of cleaning solution into the sample bottle. This enables the cleaning solution in the total organic carbon analyzer 162 to stabilize.

At this time, a flow of cleaning solution is maintained through the carbon sensing section 166. To enable a flow of cleaning solution to be maintained through the carbon sensing section 166, the valves 169 and 171 remain in an open condition and the valves 92 and 170 remain in a closed condition.

The operating characteristics of the total organic carbon analyzer 162 are such that it is utilized to first measure the concentration of the inorganic carbon in the sample of cleaning solution. After the concentration of the inorganic carbon has been measured, an ultraviolet lamp turns on and oxidation of the sample in the total organic carbon analyzer 162 is initiated. During the oxidation process the organic carbon in the sample in the total organic carbon analyzer 162 is converted to carbon dioxide (CO₂).

Inorganic carbon is electrically conducive. Organic carbon is not electrically conductive. However, carbon dioxide is conductive. Therefore, as the organic carbon in the sample of used cleaning solution in the total organic carbon analyzer 162 is oxidized to form carbon dioxide, the electrical conductivity of the sample in the total organic carbon analyzer 162 is increased. As was previously mentioned, the total organic carbon analyzer 162 may have a different construction and/or mode of operation. If this is the case, the organic carbon may not be converted to carbon dioxide.

When all of the organic carbon in the sample in the total organic carbon analyzer 162 has been oxidized to form carbon dioxide (CO₂), measurement of the final conductivity of the sample is undertaken. This measurement is indicative of the concentration of total carbon, that is, both the inorganic and organic carbon, in the sample in the total organic carbon analyzer 162. The valve 204 in the total organic carbon analyzer 162 remains closed during sensing of the concentration of inorganic carbon in the sample of cleaning solution and during oxidation of the organic carbon and subsequent sensing of the concentration of total carbon in the sample of cleaning solution.

The concentration of organic carbon is then found by subtracting the total inorganic carbon, which was measured prior to oxidizing of the organic carbon to form carbon dioxide, from the total carbon. The final measurement of the concentration of both inorganic and organic carbon in the sample in the total organic carbon analyzer 162 is conducted with the ultraviolet lamp turned off. This prevents the ultraviolet lamp from making the sample more conductive than it actually is based on total carbon content. A drain or outlet conduit may be connected with the total organic carbon analyzer to facilitate emptying the sample bottle 206 after sensing the total carbon (inorganic plus organic carbon) in the sample.

If the concentration of organic carbon in the sample of cleaning solution is less than a predetermined maximum amount, the processing equipment 14 will have been satisfactorily cleaned. If the concentration of organic carbon in the sample of cleaning solution is greater than the predetermined amount, the processing equipment 14 will not have been satisfactorily cleaned. If the concentration of organic carbon in the sample of cleaning solution is greater than the predetermined amount, additional cleaning operations will be undertaken to clean the processing equipment 14.

The total organic carbon analyzer 162 may have any desired construction. However, in one specific embodiment of the invention, the total organic carbon analyzer 162 was an Anatel A643 Total Organic Carbon (TOC) Analyzer which is commercially available from Hach Company having a place of business at 5600 Lindbergh Drive, P.O. Box 389, Loveland, CO 80539 and at 481 California Avenue, grants Pass, Oregon 97526. If desired an Anatel TOC600 or an Anatel PAT700 Total Organic Carbon Analyzer may be utilized. The Anatel TOC600 and PAT700 Analyzers are also available from Hach Company. However, it should be understood that Hach Company or other sources may be utilized to obtain similar or different organic carbon analyzers.

If desired, the total organic carbon analyzer 162 may have a construction and mode of operation similar to that disclosed in U.S. Pat. Nos. 4,775,634; 5,275,957; 5,413,763; 6,451,613; and/or 6,793,889. The aforementioned Anatel Total Organic Carbon Analyzers are of the type which takes a sample of return cleaning solution. However, a flow through type of total organic carbon analyzer may be utilized if desired. With a flow through type of total organic carbon analyzer, the carbon in a moving stream of cleaning solution is sensed rather than sensing the carbon in a quiescent sample disposed in a sample bottle or container 206.

In order to protect the total organic carbon analyzer 162 from being overloaded by an excessive concentration of residue and/or other contaminates in the solution returned from the processing equipment 14, a conductivity sensor 196 is connected with the return conduit 32 immediately upstream of the return pump 80. When it is believed that the amount of contaminates in the solution being returned from the processing equipment 14 may be low enough to enable the total organic carbon analyzer 162 to be used, operation of the return pump 80 is interrupted. While operation of the return pump 80 is interrupted, the conductivity sensor 196 is utilized to sense the conductivity of the stagnant return cleaning solution.

When the output from the conductivity sensor 196 indicates that excessive contaminates are not present in the return solution, the entrance valve 169 to the carbon sensing section 166 is opened. Immediately thereafter, the valve 170 is closed. Operation of the return pump 80 is resumed and the cleaning solution flows into the carbon sensing section 166. At this time, the valve 92 is closed and the valve 171 is open.

When an acceptable level of conductivity is present and confirmed by using the conductivity sensor 196, a sample of the cleaning solution in the conduit 202 is conducted into the total organic carbon analyzer 162. By experimentation it has been established that when conductivity values greater than approximately 0.80 micro-Siemens are present in the stagnant return cleaning solution, the contaminate level may be excessive. It should be understood that a different conductivity value may be used to establish whether or not excessive contamination is present in the cleaning solution. These contaminates may be cleaning agent and/or material residues remaining after the wash and/or rinse cycles of a cleaning program.

The controls 82 for the cleaning equipment 12 initiate the sensing of the total organic carbon in the return solution only after the output from the conductivity sensor 196 is less than a predetermined conductivity level (a threshold valve). In the illustrated clean-in-place unit 12 this predetermined conductivity was 0.80 micro-Siemens (less than 0.80 μS). It is believed that it may be desired to have the output from the conductivity sensor 196 be approximately 0.75 micro-Siemens (0.75 μS) before the total organic carbon analyzer 162 is utilized to determine the concentration of organic carbon in the solution returned from the processing equipment 14. It is contemplated that the sensing of the total organic carbon in the return solution may be initiated when output from the conductivity sensor is different than the aforementioned outputs.

It should be understood that use of the total organic carbon analyzer 162 may be undertaken without relying upon the conductivity sensor 196 to indicate that excessive contaminates are not present. For example, if, it is found that excessive contaminates are not present at certain times in the cleaning cycle, operation of the total organic carbon analyzer 162 may be automatically undertaken at these times without use of the conductivity sensor 196.

### Operation

A typical sequence of operation for the cleaning equipment 12 during the cleaning of a fermentor/bio reactor has been established. However, it should be understood that other sequences of operation of the cleaning equipment 12 may be utilized. The typical sequence includes a pre-rinse cycle which is performed with relatively low or ambient temperature USP purified water as a cleaning solution in order to avoid denaturizing protein based residues in the processing equipment 14. A batch of USP purified water is conducted into the tank 40 using conduit 48. Prior to initiating the pre-rinse cycle on the processing equipment 14, the batch of USP purified water is circulated internally of the clean-in-place unit 12. Thus, prior to initiation of the pre-rinse cycle, the cleaning solution (USP purified water) was conducted through the recirculation conduit 86 and open recirculation value 88 to the heat exchanger 84. The cleaning solution was conducted from the heat exchanger 84 to the static spray balls 66 and 68 in the tank 40. This resulted in the body of cleaning solution (USP purified water) in the tank 42 having a uniform temperature throughout the body of cleaning solution.

During the pre-rinse cycle, return cleaning solution went directly from the return pump 80 to drain through the conduit 168. Therefore, during the pre-rinse cycle, the multistage supply pump 72 is operated to induce a flow of purified water from the tank 40 to the processing equipment 14 through the cleaning solution supply conduit 30.

After the receptacle 16 has been rinsed, the used cleaning solution (rinse water) is conducted through the conduit 32 (FIG. 1) to the single stage return pump 80 (FIG. 2). The used rinse solution is conducted from the return pump 80 to drain through the open valves 170 and 171. At this time, the valves 88 and 92, and 169 are closed.

After the pre-rinse cycle, a first wash cycle is undertaken. During this first wash cycle, a sodium hydroxide based caustic cleaning solvent is supplied from the cleaning solvent tank 54 (FIG. 2) to the main tank 40 of the cleaning equipment 12. In addition, USP purified water from the conduit 48 is supplied to the tank 40.

Prior to initiation of the first wash cycle, the cleaning solution containing the caustic cleaning solvent and purified water was conducted from the multistage supply pump 72 through the recirculation conduit 86 and open recirculation valve 88 to the heat exchanger 84. The cleaning solution was conducted from the heat exchanger 84 to the static spray balls 66 and 68 in the tank 40. This resulted in the body of cleaning solution (USP purified water and caustic solvent) in the tank 40 having a uniform temperature and composition throughout the body of cleaning solution.

During the first wash cycle, the multistage supply pump 72 is driven by the motor 74 to induce a flow of the first cleaning solution from the tank 42 through the conduit 30 to the cleaning solution dispensing device 24 in the processing equipment 14. Used cleaning solution is conducted from the processing equipment 14 to the return pump 80 (FIG. 2) through the return conduit 32. At this time, the drain valve 170 is closed and the valve 92 is open. This results in the used cleaning solution being conducted through the heat exchanger 84 where the temperature of the solution was maintained at a predetermined temperature. The heat exchanger 84 maintains the temperature of the used cleaning solution at a predetermined (specified) temperature. This temperature may be between 10 and 95 degrees Centigrade. Of course, the heat exchanger 84 may be used to heat the used cleaning solution to any desired temperature.

The used cleaning solution was conducted from the heat exchanger 84 to the static spray balls 66 and 68 in the interior of the tank 40. The static spray balls 66 and 68 promote the formation of a uniform (homogenous) body of cleaning solution in the tank 40. The body of cleaning solution in the tank 40 will have a uniform composition and temperature.

The supply pump 72 induces a flow of the cleaning solution from the tank 40 through the cleaning solution supply conduit 30 to the cleaning solution dispensing device 24 (FIG. 1) in the processing equipment 14. The return pump 80 is effective to return cleaning solution from the processing equipment 14 to the tank 40. The number of times the cleaning solution is recirculated during the first wash cycle will depend upon the arrangement of surfaces to be cleaned in the processing equipment 14 and the difficulty encountered in removing residues from the surfaces. During operation of the supply pump 72, the pressure sensor 110 cooperates with the controller 114 to maintain a desired pressure in the flow of cleaning solution conducted through the supply conduit 30.

After the first wash cycle has been completed, a post rinse cycle is undertaken. The post rinse cycle may be performed with either hot or relatively low or ambient temperature USP purified water as a cleaning solution. The post rinse cycle is directed at removing detergent residues remaining in the processing equipment 14 (FIG. 1) after the first wash cycle. The supply pump 72 induces a flow of the rinse solution from the tank 40 to the processing equipment 14 through the cleaning solution supply conduit 30. This flow of rinse water is effective to remove caustic detergent residues from the processing equipment 14.

Used rinse solution is returned to the cleaning equipment 12 by the return pump 80 through the return conduit 32. The used rinse solution is conducted to drain without being recirculated. At this time, the valve 92 is closed and the drain valve 170 is open.

A second wash cycle is then undertaken, the second wash cycle utilizes a acid based detergent, for example, a citric acid based detergent (solvent) or a phosphoric acid detergent is supplied from the cleaning solvent tank 69 (FIG. 2) to the main tank 40 of the cleaning equipment 12. In addition, USP purified water from the conduit 48 is supplied to the tank 40.

Prior to initiation of the second wash cycle, the cleaning solution containing the acidic cleaning solvent and USP purified water was conducted from the multistage supply pump 72 through the recirculation conduit 86 and open recirculation valve 88 to the heat exchanger 84. The cleaning solution was conducted from the heat exchanger 84 to the static spray balls 66 and 68 in the tank 40. This resulted in the body of cleaning solution (USP purified water and acidic solvent) in the tank 40 having a uniform temperature and composition throughout the body of cleaning solution.

During the second wash cycle, the acid based cleaning solution is conducted from the main thank 40 to the multistage supply pump 72. The acid based cleaning solution is conducted form the supply pump 72 to the dispensing device 24 in the receptacle 16.

During the second wash cycle, the drain valve 170 is closed and the valve 92 is open. This results in the cleaning solution returned from the processing equipment 14 (FIG. 1) by the return pump 80 (FIG. 2) being conducted through the heat exchanger 84 to maintain the temperature of the cleaning solution. The heat exchanger 84 maintains the cleaning solution at a temperature specified for the cleaning process. This temperature may be between 10 and 95 degrees Centigrade.

The recirculated cleaning solution is directed into the tank 40 (FIG. 2) through the static spray balls 66 and 68. The static spray balls promote the formation of a homogeneous body of cleaning solution having a uniform temperature and composition. The cleaning solution is then pumped from the tank 40 by the supply pump 72 to the processing equipment 14. During operation of the supply pump 72, the pressure sensor 110 and controller 114 cooperate with the motor 74 to maintain a desired fluid pressure and flow rate in the cleaning solution supply conduit 30.

During the second wash cycle, the second cleaning solution, an acid base cleaning solution, is recirculated for a desired amount of time. The drain valve 170 is then opened and the valve 92 is closed. This results in the second (acid base) cleaning solution being directed to drain.

After the second wash cycle, a second post rinse cycle is undertaken. During the second post rinse cycle, relatively high temperature sterile water, that is, USP water for injection is used as a cleaning solution. If desired, USP purified water may be used as the cleaning solution during the second post rinse cycle. The rinse water is conducted from the tank 40 in the cleaning equipment 12 (FIG. 2) to the processing equipment through the cleaning solution supply conduit 30. This cleaning solution is heated water. The drain valve 170 remains open so that the second rinse solution passes through the processing equipment 14 only once.

After the second rinse cycle has been performed, a final rinse cycle is undertaken. At this time, the drain valve 170 is open and the valve 92 is closed. Therefore, the cleaning solution (rinse water) is conducted from the return pump 80 to drain. During the final rinse cycle water with the highest cleanliness and purity is applied typically USP water for injection. The water is at a relatively high temperature. During the final rinse operation, the single stage return pump 80 is operated to induce a flow of cleaning solution from the receptacle 16 back to the cleaning equipment 12 through the cleaning solution return conduit 32.

Operation of the return pump 80 is interrupted for a brief time to enable the conductivity sensor 196 to measure the conductivity of the static return final rinse solution in the return conduit 32. When the conductivity of the return final rinse solution, as measured by the conductivity sensor 196, is less than a predetermined threshold conductivity limit, the drain valve 170 is closed and the entrance valve 169 to the carbon sensing section 166 is opened. This results in the rinse solution being conducted through the heat exchanger 184. If necessary the final rinse solution is cooled in the heat exchanger 184 before being conducted to the total organic carbon analyzer 162.

During the final rinse, the return pump 80 is operated to remove the waste water from the receptacle 16 directly to the drain using conduit 168. Valve 92 is closed. The final rinse water is not recirculated back to the tank 40.

During the final rinse, the operation of the return pump 80 is paused to enable the conductivity sensor 196 to measure the electrical conductivity of the final rinse water in the return conduit 32 under stable measuring conditions (no air bubbles, turbulence, etc). The conductivity is measured in the micro Siemens range and the value communicated to the controls 82 in the clean-in-place unit 14. If the conductivity measured by the conductivity sensor 196 is above a pre-established threshold conductivity limit, the controls 82 initiate measurement of total organic carbon in the return cleaning solution (final rinse water). It is believed that it may be desired to have the aforementioned pre-established threshold conductivity be less than 0.8 micro-Siemens (μS).

When measurement of the total organic carbon is to be initiated by the controls 82, valve 179 to the carbon sensing section 166 is opened. The drain valve 170 is closed. At this time, the valve 92 remains closed and the valve 171 remains open. Operation of the return pump 80 is resumed to induce a flow of cleaning solution (final rinse water) through the carbon sensing section 166.

After a small volume (sample) of the final rinse solution has been conducted through the valve 204 into the sample bottle or container 206 in the total organic carbon analyzer 162, the total organic carbon analyzer is operated to determine the concentration of organic carbon in the cleaning solution. As was previously indicated, this is accomplished by first measuring the inorganic carbon concentration. After energizing an ultraviolet light, the total carbon concentration (both organic and inorganic) in the return final rinse solution is measured. The total inorganic carbon concentration is subtracted from the total carbon concentration to determine the total organic carbon concentration in the cleaning solution.

If there is excessive organic carbon in the final rinse solution, it is a clear indication that the processing equipment 14 is not as clean as is desired. However, if the total organic carbon concentration in the return rinse is equal to or less than a predetermined amount, it is a clear indication that the processing equipment 14 has been properly cleaned. The control unit 82 (FIG. 1) in the cleaning equipment 12 provides a written or electronic final batch report indicating the manner in which the processing equipment 14 was cleaned and the resulting total organic carbon content of the final rinse solution. An illustrative example of a final batch report is set forth below:

CIP Test Report #1

| | Pre rinse 1 | | Pre rinse 2 | | Wash 1 | | Post rinse | | Wash 2 | | Post rinse 2 | | Final rinse | |
|---|---|---|---|---|---|---|---|---|---|---|---|---|---|---|
| | SP | PV | SP | PV | SP | PV | SP | PV | SP | PV | SP | PV | SP | PV |
| Number of repetition | 2 | 2 | — | — | 1 | 1 | 1 | 1 | 1 | 1 | 1 | 1 | 1 | 1 |
| High | 6 | — | — | — | 6 | — | 6 | — | 6 | — | 6 | — | 6 | — |
| Pressure (bar g) | | 4.7 | — | — | | 4.8 | | 4.9 | | 5 | | 4.9 | | 4.8 |
| Low | 4 | — | — | — | 4 | — | 4 | — | 4 | — | 4 | — | 4 | |
| Level, vessel (liters) | 150 | 151 | — | — | 200 | 202 | 125 | 124 | 200 | 198 | 125 | 126 | 225 | 227 |
| Duration time (sec) | 55 | 55 | | | 360 | 360 | 45 | 40 | 240 | 240 | 45 | 46 | 100 | 105 |
| Temperature (° C.) | 45 | 46 | — | — | 65 | 66 | 60 | 62 | 60 | 59 | 80 | 82 | 25 | 26.7 |
| Cleaning agent 1 (kg) | — | — | — | — | 0.75 | 0.78 | — | — | 0.55 | 0.57 | — | — | — | — |
| Cleaning agent 2 (kg) | — | — | — | — | — | — | — | — | — | — | — | — | — | — |
| TOC (ppb) | — | — | — | — | — | — | — | — | — | — | — | — | — | 7.3 |
| High | — | — | — | — | 5 | — | — | — | 5 | — | — | — | 0.85 | |
| Conductivity (μS/cm) | — | — | | | — | 3.75 | — | — | — | 2.5 | — | | | 0.72 |
| Low | — | — | — | — | 2 | — | — | — | 2 | — | — | — | — | — |
| Flow (lpom) | — | 65 | | | | 63 | — | 66 | | 63 | — | 64 | — | — |
| Drain CIP internal | 30 | 30 | — | — | 30 | 30 | 30 | 30 | 30 | 30 | 30 | 30 | 60 | 60 |
| Drain Supply (sec) | 30 | 30 | — | — | 30 | 30 | 30 | 30 | 30 | 30 | 30 | 30 | 60 | 60 |
| Drain w/pump | 20 | 20 | — | — | 20 | 20 | 20 | 20 | 20 | 20 | 20 | 20 | 30 | 30 |

In the foregoing final batch report, the column heading “SP” refers to set point. The set point (SP) is a pre-determined, validated, value in the cleaning program. The column heading “PV” refers to process value. The process value (PV) is the value measured by instruments and documented by instruments. Although the set point (SP) and process value (PV) are ideally the same, there is frequently a small difference between the two values.

It should be understood that the final batch report set forth above is merely for illustrative purposes and that the cleaning procedures, times, pressure and temperatures may be different from the specific values set forth in the report. The report has been set forth herein for purposes of clarity of description and not for purposes of limiting the invention.

### Acoustical Sensing

During operation of the apparatus 10 (FIG. 1) unforeseen malfunctions may occur during operation of the cleaning equipment 12 and/or cleaning solution dispensing device 24. If the occurrence of an unforeseen malfunction of either the cleaning equipment 12 or the cleaning solution dispensing device 24 is quickly detected, the cause of the malfunction can be determined and the malfunctioning aspect of the cleaning equipment or cleaning solution dispensing device corrected.

In order to detect an unforeseen malfunctioning of the cleaning equipment 12 and/or cleaning solution dispensing device 24, an acoustical sensor 210 (FIG. 1) is provided in association with the receptacle 16. The acoustical sensor 210 is an added safety feature that ensures correct operation of the dispensing device 24. The acoustical sensor 210 senses any change in the sound which is generated during dispensing of cleaning solution from the dispensing device 24. During the use of the cleaning equipment 12 and dispensing device 24, the sound which is generated should continuously vary in a predictable manner. However, if the sound which is generated during use of the cleaning equipment 12 and dispensing device 24 is outside predetermined maximum or minimum levels, it is indicative of a malfunctioning of the cleaning equipment 12 and/or dispensing device 24.

The acoustical sensor 210 senses the sound which is generated by impingement of cleaning solution against surfaces in the receptacle 16. The acoustical sensor 210 is a microphone which functions as an acoustical-electric transducer. The acoustical sensor 210 converts sound into an electrical signal. This electrical signal is transmitted over a lead or conductor 214 to the controls in the cleaning equipment 12. The acoustical sensor 210 may be used with just dynamic dispensing devices 24, with just static dispensing devices, or with a combination of dynamic and static dispensing devices.

An illustrative electrical signal associated with a dynamic dispensing device 24 is illustrated schematically at 220 in FIG. 5. Due to rotation of components of the cleaning agent dispensing device 24, the electrical signal 220 may vary in a generally wavelike manner. The electrical signal 220 associated with a static dispensing device 24 will be different than the electrical signal (FIG. 5) associated with a dynamic dispensing device. The electrical signal associated with a static dispensing device 24 may be relatively constant.

As long as the value of the electrical signal 220 remains between a predetermined minimum value, indicated at 224 in FIG. 5, and a predetermined maximum value, indicated at 226 in FIG. 5, the noise generated during operation of the cleaning solution dispensing device 24 is within an acceptable range. However, if the noise generated by operation of the cleaning solution dispensing device 24 exceeds the predetermined maximum value, in the manner indicated schematically at 230 in FIG. 5, there is excessive noise being generated by the operation of the cleaning agent dispensing device 24. Similarly, if the electrical signal 220 falls below the predetermined minimum value, in the manner indicated at 234 of FIG. 5, there is insufficient noise being generated by the operation of the cleaning solution dispensing device 24. In response to either an excessive noise signal, as indicated at 230 in FIG. 5, or an insufficient noise signal, as indicated at 234 in FIG. 5, corrective action may be undertaken.

It is contemplated that the acoustical sensor 210 may have any one of many different known constructions. For example, a condenser microphone may be utilized as the acoustical sensor. Alternatively, a crystal microphone utilizing a piezoelectric unit may be the acoustical sensor. If desired, a transducer having the construction similar to the construction disclosed in U.S. Pat. No. 4,763,513 may be utilized as the acoustical sensor 210.

### CONCLUSION

In view of the foregoing description it is apparent that the present invention provides a new and improved method and apparatus for the cleaning of processing equipment 14. The processing equipment 14 may include a receptacle 16 which holds material during operation of the processing equipment. A cleaning solvent, which is suitable for use in removing material remaining in the receptacle 16, is selected. The concentration of the selected cleaning solvent to be used in a cleaning solution is determined. In addition, the arrangement of surfaces in the receptacle 16 which are to be cleaned is determined. One or more dispensing devices 24 may be located at selected positions in the receptacle 16.

Equipment 12 for use in cleaning a receptacle 16 may include a tank 40 which is at least partially filled with a cleaning solution containing the selected cleaning solvent. A multistage pump 72 having a plurality of impellers 122 may be utilized to pump the cleaning solution from the tank 40 to a supply conduit 30. The speed at which the pump 72 is driven may be varied as a function of fluid pressure in the supply conduit 30. A single stage return pump 80 having a single impeller 150 may be used to pump cleaning solution from the receptacle 16

The multistage pump 72 may be operated to discharge cleaning solution to the supply conduit 30 at a rate of between 10 gallons per minute and 125 gallons per minute. The fluid flow from the multistage pump 72 may be at a pressure between 60 pounds per square inch (gauge) and 250 pounds per square inch (gauge).

If desired, control apparatus 82 associated with the cleaning equipment 12 may include an acoustic sensor 210. The acoustic sensor 210 is operable to detect sound resulting from the dispensing of cleaning solution from the dispensing device 24 in the receptacle 16. A control function is initiated in response to sensing a change in the sound resulting from the dispensing of the cleaning solution.

If desired, the concentration of organic carbon contained in the cleaning solution pumped from the receptacle with a return pump may be determined. The concentration of organic carbon may be determined after the electrical conductivity of the cleaning solution has been sensed. The sensing of the electrical conductivity of the cleaning solution may occur while operation of the return pump 80 is interrupted.

The present invention has a plurality of features which may be utilized together as disclosed herein. Alternatively, the various features of the present invention may be used separately or in various combinations with each other. It is contemplated that one or more of the features of the present invention may be utilized in association with features from the prior art. For example, the multistage supply pump 72 may be used without the total organic carbon analyzer 162 and/or without the acoustical sensor 210. As another example, the total organic carbon analyzer 162 may be used with cleaning equipment which does not include a multistage pump.

Having described the invention, the following is claimed:

1. A method of cleaning processing equipment which includes a receptacle which holds material during operation of the equipment, said method comprising the steps of providing at least one cleaning solution dispensing device to be used in directing a flow of cleaning solution toward surface areas in the receptacle, providing a tank, at least partially filling the tank with cleaning solution, pumping cleaning solution from the tank to the dispensing device in the receptacle with a multistage pump, said step of pumping cleaning solution from the tank to the dispensing device includes operating a variable speed electric motor to rotate a plurality of impellers in the multistage pump to induce a flow of cleaning solution from the multistage pump to a cleaning solution supply conduit connected in fluid communication with the dispensing device, sensing fluid pressure in the cleaning solution supply conduit, varying a speed at which the variable speed electric motor rotates the plurality of impellers of the multistage pump as a function of the sensed fluid pressure in the cleaning solution supply conduit, and pumping cleaning solution from the receptacle with a single stage pump, said step of pumping cleaning solution from the receptacle includes rotating a single impeller of the single stage pump to induce a flow of cleaning solution in a return conduit.

2. A method as set forth in claim 1 further including the steps of detecting sound generated by operation of the dispensing device during pumping of cleaning solution from the tank to the dispensing device, and initiating a control function in response to sensing of a change in the sound generated by operation of the dispensing device.

3. A method as set forth in claim 1 further including the step of sensing concentration of organic carbon contained in the cleaning solution pumped from the receptacle with the single stage pump.

4. A method as set forth in claim 1 further including the steps of measuring the electrical conductivity of cleaning solution pumped from the receptacle with the single stage pump, determining when the concentration of contaminates in the cleaning solution pumped from the receptacle is less than an excessive concentration of contaminates as a function of the electrical conductivity measured during performance of said step of measuring the electrical conductivity of the cleaning solution, conducting cleaning solution pumped from the receptacle to a total organic carbon sensor after having determined that the concentration of contaminates in the cleaning solution is less than an excessive concentration of contaminates as a function of the electrical conductivity of the cleaning solution, and, thereafter, utilizing the total organic carbon sensor to determine the concentration of organic carbon in the cleaning solution pumped from the receptacle.

5. A method as set forth in claim 4 further including the step of cooling the cleaning solution prior to conducting the cleaning solution to the total organic carbon sensor.

6. A method as set forth in claim 4 further including the step of interrupting operation of the single stage pump prior to performing said step of measuring the electrical conductivity of the cleaning solution from the receptacle, said step of measuring the electrical conductivity of the cleaning solution pumped from the receptacle is performed while the single stage pump is not operating.

7. A method as set forth in claim 4 wherein said step of measuring the electrical conductivity of the cleaning solution is performed at a location disposed along the return conduit between the single stage pump and the receptacle.

8. A method as set forth in claim 7 wherein said step of utilizing the total organic carbon sensor to determine the concentration of organic carbon in the cleaning solution is performed at a location disposed along the return conduit downstream from the single stage pump.

9. A method as set forth in claim 1 further including the steps of conducting cleaning solution from the single stage pump through a heat exchanger, heating the cleaning solution as it is conducted through the heat exchanger, and conducting a flow of heated cleaning solution from the heat exchanger to the tank.

10. A method as set forth in claim 1 wherein said step of pumping cleaning solution from the tank to the dispensing device with a multistage pump includes discharging cleaning solution from the multistage pump at a rate of between 10 gallons per minute and 125 gallons per minute and at a pressure between 60 pounds per square inch (gauge) and 250 pounds per square inch (gauge).

11. A method as set forth in claim 1 further including the step of operating the multistage pump to induce a flow of cleaning solution from the cleaning solution supply conduit to the tank through a recirculate conduit without having the cleaning solution conducted to the receptacle to promote formation in the tank of a body of cleaning solution having a uniform temperature and composition.

12. A method as set forth in claim 1 further including the step of conducting a flow of purge gas through the cleaning solution supply conduit to the dispensing device to blow any cleaning solution remaining in the dispensing device out of the dispensing device.

13. A method of cleaning processing equipment which includes a receptacle which holds material during operation of the equipment, said method comprising the steps of selecting a cleaning solvent which is suitable for use in removing material remaining in the receptacle after operation of the equipment, determining the arrangement in the receptacle of surfaces which are to be cleaned, determining the concentration of the selected cleaning solvent to be used in a cleaning solution for the surfaces in the receptacle which are to be cleaned, determining the type of cleaning solution dispensing device to be used in directing a flow of cleaning solution toward the surfaces in the receptacle which are to be cleaned, positioning one or more selected dispensing devices at one or more selected locations in the receptacle, determining the temperature at which the cleaning solution is to be dispensed from the dispensing devices, providing a tank, at least partially filling the tank with cleaning solution, pumping cleaning solution from the tank to the dispensing device in the receptacle with a multistage pump, said step of pumping cleaning solution from the tank to the dispensing device is performed with the cleaning solution, at a temperature which is a function of the temperature at which the cleaning solution is to be dispensed from the dispensing device in the receptacle, said step of pumping cleaning solution from the tank to the dispensing device includes operating an electric motor to rotate a plurality of impellers in the multistage pump and discharging cleaning solution from the multistage pump to a fluid conduit connected with the dispensing device at a rate of between 10 gallons per minute and 125 gallons per minute and at a pressure between 60 pounds per square inch (gauge) and 250 pounds per square inch (gauge).

14. A method as set forth in claim 13 further including the step of positioning an acoustic sensor to detect sound resulting from the dispensing of the cleaning solution from the dispensing device and initiating a control function in response to sensing a change in the sound resulting from dispensing of the cleaning solution.

15. A method as set forth in claim 13 further including the step of pumping cleaning solution from the receptacle, said step of pumping cleaning solution from the receptacle includes conducting a flow of cleaning solution from the receptacle through a first conduit to a single stage return pump and conducting a flow of cleaning solution from the single stage return pump through a second conduit, sensing when the concentration of contaminates in the cleaning solution in the first conduit is less than a predetermined amount, and, after sensing that the concentration of contaminates in the cleaning solution in the first conduit is less than the predetermined amount, determining the concentration of organic carbon in the cleaning solution in the second conduit.

16. A method as set forth in claim 15 further including the step of interrupting operation of the single stage return pump and performing said step of sensing the concentration of contaminates in the cleaning solution in the first conduit while operation of the single stage return pump is interrupted.

17. A method as set forth in claim 16 further including the step of resuming operation of the single stage return pump after having performed said step of sensing the concentration of contaminates in the cleaning solution in the first conduit and, thereafter and while the return pump is operating, sensing the concentration of carbon in the cleaning solution in the second conduit.

18. A method as set forth in claim 15 further including the step of cooling the cleaning solution in the second conduit prior to performing said step of sensing the carbon in the cleaning solution in the second conduit.

19. A method of cleaning processing equipment which includes a receptacle which holds material during operation of the equipment, said method comprising the steps of providing at least one cleaning solution dispensing device to be used in directing a flow of cleaning solution toward surface areas in the receptacle which are to be cleaned, providing a tank, at least partially filling the tank with cleaning solution, pumping cleaning solution from the tank to the dispensing device with a supply pump, pumping cleaning solution from the receptacle by operating a return pump, said step of pumping cleaning solution from the receptacle by operating the return pump includes conducting a flow of cleaning solution through a return conduit which is connected in fluid communication with the return pump and the receptacle, interrupting operation of the return pump, measuring electrical conductivity of cleaning solution upstream of the return pump at a location disposed along the return conduit between the return pump and the receptacle while operation of the return pump is interrupted, resuming operation of the return pump, and, thereafter, determining the concentration of organic carbon in cleaning solution at a location disposed along the return conduit downstream from the return pump if the measured conductivity of the cleaning solution is less than a predetermined amount.

20. A method as set forth in claim 19 wherein said step of pumping cleaning solution from the tank to the dispensing device with a supply pump includes operating a variable speed electric motor to rotate a plurality of impellers in a multistage pump, sensing fluid pressure in a cleaning solution supply conduit which is connected in fluid communication with the supply pump and the dispensing device, and varying a speed at which the variable speed motor rotates the plurality of impellers of the multistage pump as a function of fluid pressure in the cleaning solution supply conduit.

21. A method as set forth in claim 20 wherein said step of pumping cleaning solution from the tank to the dispensing device with a supply pump includes discharging cleaning solution from the supply pump at a rate of between 10 and 125 gallons per minute and at a pressure between 60 pounds per square inch (gauge) and 250 pounds per square inch (gauge).

22. A method as set forth in claim 21 further including the steps of detecting sound generated by operation of the dispensing device during pumping of cleaning solution from the tank to the dispensing device, and initiating a control function in response to sensing of a change in the sound generated by operation of the dispensing device.

23. A method as set forth in claim 19 further including the step of cooling the cleaning solution before performing said step of determining the concentration of organic carbon in the cleaning solution, said step of cooling the cleaning solution includes conducting a flow of the cleaning solution through a heat exchanger and conducting a flow of cooling solution through the heat exchanger with the flow of cooling solution at a temperature which is less than a temperature of the cleaning solution.

24. A method of cleaning processing equipment which includes a receptacle which holds material during operation of the equipment, said method comprising the steps of providing at least one cleaning solution dispensing device to be used in directing a flow of cleaning toward surface areas in the receptacle which are to be cleaned, providing a tank, at least partially filling the tank with cleaning solution, pumping cleaning solution from the tank to the dispensing device in the receptacle with a multistage pump, said step of pumping cleaning solution from the tank to the dispensing device includes operating a variable speed electric motor to rotate a plurality of impellers in the multistage pmp to induce a flow of cleaning solution from the multistage pump to at least one supply conduit connected with the at least one dispensing device at a flow rate of between 10 gallons per minute and 125 gallons per minute and at a pressure between 60 pounds per square inch (gauge) and 250 pounds per square inch (gauge), sensing fluid pressure in the supply conduit, and varying a speed at which the variable speed electric motor rotates the plurality of impellers as a function of the sensed fluid pressure in the supply conduit.

25. A method as set forth in claim 24 further including the steps of detecting sound generated by engagement of the flow of cleaning solution from the dispensing device with surfaces in the receptacle, and initiating a control function in response to sensing of a change in the sound.

26. A method as set forth in claim 24 further including the step of pumping cleaning solution from the receptacle and utilizing a total organic carbon sensor to determine the concentration of organic carbon in the cleaning solution pumped from the receptacle.
